(19) United States
(12) Patent Application Publication
(10) Pub. No.: US 2015/0222667 A1
(43) Pub. Date: Aug. 6, 2015

(54) PROTECTION SYSTEM INCLUDING SECURITY RULE EVALUATION

(71) Applicants: Alex Nayshtut, Gan Yavne (IL); Igor Muttik, Hertfordshire (GB); Yaniv Avidan, Moshav Mahseya (IL)

(72) Inventors: Alex Nayshtut, Gan Yavne (IL); Igor Muttik, Hertfordshire (GB); Yaniv Avidan, Moshav Mahseya (IL)

(21) Appl. No.: 14/360,094

(22) PCT Filed: Dec. 2, 2013
(86) PCT No.: PCT/US2013/072654

§ 371 Date: May 22, 2014

(51) Int. Cl. H04L 29/06; G06N 5/02

(52) U.S. Cl. CPC H04L 63/20; G06N 5/025; H04L 63/1433

(57) ABSTRACT

This disclosure is directed to a protection system including security rule evaluation. A device may comprise a protection module to identify threats to at least one of the device or to a network including the device. The protection module may include, for example, a rule evaluator (RE) module to evaluate proposed security rules for identifying the threats based on at least one ground truth scenario and to determine whether to promote the proposed security rules to new security rules. The proposed security rules may be generated by the protection module or received from other devices in the network or other networks. New security rules may be shared with the other devices and/or networks. The RE module may further trigger an independent evaluation of the proposed security rules, which may also be considered when determining whether to add the proposed security rules to the set of active rules in the device.

### TECHNICAL FIELD

The present disclosure relates to protection systems, and more particularly, to a device and/or network threat monitoring system that is able to evaluate proposed security rules.

### BACKGROUND

In modern society, computing devices are moving from just being a convenience to a requirement. Communications are becoming predominantly electronic on a global scale, and these communications often include the transmission of sensitive or confidential information. For example, a user may transmit personal identification information, may conduct financial transactions, may receive medical data, etc. via electronic communication. On a larger scale, small businesses, corporations, educational institutions, governmental entities may all utilize electronic communication to conduct business deals, to execute confidential documents, etc. All of this data residing on, or being conveyed through, electronic devices may be attractive to unauthorized parties that wish to utilize it for their own benefit. Thus, device-level and/or network-level protection systems including, but not limited to, virus and malware protection software, unauthorized access prevention (e.g., network security monitors and intrusion detection/prevention systems), etc. have become required applications.

Existing device protection systems are typically centrally administered. For example, a protection client is usually installed on the device to be protected with software updates for the protection client being pushed out from a network administrator or security provider (e.g., a global company that provides security equipment and/or software). The software updates may, for example, comprise updated rules, definitions, etc. used to identify threats to devices and/or networks including the devices (e.g., viruses, worms, intrusions, any suspicious or malicious activity conducted by humans or malware either within endpoint devices, in the network or in both, etc.). While this model of protection may have been effective in the past, the increasing interest of unauthorized parties to capture and/or intercept sensitive and/or confidential data has rendered inadequate the “one size fits all” approach to device and/or network protection. This shift is a result of the vast variability of network sizes, parameters and configurations. Traditional centralized security approaches worked reasonably well when protecting uniform endpoints (e.g., all Windows-based, all Android based, etc.) but creating centralized rules to protect a multitude of different devices and/or networks is much more challenging. Different operational environments may comprise unique threats to devices and/or networks, some of which may not be readily apparent to a centralized administrator or security provider outside of the environment. Given these challenges, it becomes very difficult to generate an effective security strategy that meets all of the needs of the entire network. Moreover, while devices operating in a network environment may have input as to possible security configurations, there is no manner for the centralized administrator to effectively process this information.

### BRIEF DESCRIPTION OF THE DRAWINGS

Features and advantages of various embodiments of the claimed subject matter will become apparent as the following Detailed Description proceeds, and upon reference to the Drawings, wherein like numerals designate like parts, and in which:

FIG. 1 illustrates an example protection system including security rule evaluation in accordance with at least one embodiment of the present disclosure;

FIG. 2 illustrates an example configuration for a device in accordance with at least one embodiment of the present disclosure; and

FIG. 3 illustrates example operations for a protection system including security rule evaluation in accordance with at least one embodiment of the present disclosure.

Although the following Detailed Description will proceed with reference being made to illustrative embodiments, many alternatives, modifications and variations thereof will be apparent to those skilled in the art.

### DETAILED DESCRIPTION

This disclosure is directed to a protection system including security rule evaluation. In one embodiment, a device may comprise a protection module to identify threats to at least one of the device or to a network including the device. The protection module may include, for example, a rule evaluator (RE) module to evaluate proposed security rules for identifying the threats based on at least one ground truth scenario and to determine whether to promote the proposed security rules to new security rules (e.g., to incorporate the proposed security rules into a set of active security rules in the device) based at least on the evaluation. The proposed security rules may be generated by the protection module or may be received from other devices in the network or other networks. New security rules may be shared with at least one of other devices in the network or other networks. Prior to transmission the new security rules may be normalized, if necessary, to facilitate compatibility of the new security rules with the other devices and/or networks. In one embodiment, the RE module may further trigger an independent evaluation of the proposed security rules, which may also be considered when determining whether to add the proposed security rules to the set of active rules in the device. Independent evaluation may include, for example, a manual or automatic code review, quality check, etc. performed by any network, Internet or distributed service.

In one embodiment, a device may comprise, for example, at least a protection module. The protection module may be to identify threats to at least one of the device or a network including the device. The protection module may include at least an RE module to evaluate at least one proposed security rule for use by the protection module in identifying the threats based on at least one ground truth scenario and determine whether to allow the at least one proposed security rule to become at least one new security rule based at least on the evaluation. If it is determined that the at least one proposed security rule is allowed to become at least one new security rule, the RE module may further cause the at least one new security rule to be added to an active set of security rules for use by the protection module.

The protection module may further generate the at least one proposed security rule based on a machine learning algorithm for determining threats to the at least one of the device or to the network including the device. The at least one ground truth scenario may comprise, for example, at least one known good operational scenario or known bad operational scenario. The RE module being to evaluate the at least one proposed security rule may then comprise the RE module being to determine if a threat identification generated by the at least one proposed security rule corresponds to the at least one known good operational scenario or known bad operational scenario. In the same or a different embodiment, the RE module may further be to determine whether to cause an independent evaluation of the at least one proposed security rule to be performed. In this instance, the RE module may further be to cause the independent evaluation of the at least one proposed security rule to be performed and determine whether to allow the at least one proposed security rule to become the at least one new security rule also based on the independent evaluation.

In the one embodiment, the device may further comprise a communication module to receive the at least one proposed security rule from at least one of a protection module in another device in the network or from at least one other network. In this instance, the RE module may further be to cause the communication module to transmit the at least one new security rule to at least one of the other device in the network or to the at least one other network. The RE module may further be to determine if the at least one new security rule requires normalization prior to transmission, and if it is determined that the at least one new security rule requires normalization, alter the at least one new security rule to facilitate compatibility with at least one of the other device in the network or the at least one other network. The at least one new security rule may be transmitted to the other device in the network or the other network based on a determination of applicability of the at least one new security rule to the other device or the other network by the RE module. A method consistent with the present disclosure may comprise, for example, evaluating at least one proposed security rule in a device, the at least one proposed security rule being used in the device to identify a threat to at least one of the device or a network including the device based on at least one ground truth scenario, determining whether to allow the at least one proposed security rule to become at least one new security rule based at least on the evaluation, and if it is determined that the at least one proposed security rule is allowed to become at least one new security rule, causing the at least one new security rule to be added to an active set of security rules in the device.

At least one approach to device protection is to employ large Security Information and Event Management (SIEM) systems that identify and report suspicious actions. SIEM systems may gather and process voluminous amounts of data from a multitude of network servers and devices representing activity of thousands of endpoints (e.g., “Big Data”). SIEMs may identify some activities as suspicious (e.g., threats, risks or security events) in a fully automatic manner. The quality of the identification performed by a SIEM is reflected directly in the number of alerts (e.g., especially incorrect alerts also known as false positives (FP)) which a SIEM system is generating. If the volume of the alerts is excessive, then the amount of resources required to process all of them grows, and conversely, the accuracy of the threat identification may drop due to the existence of FPs and false negatives (FNs). Embodiments consistent with the present disclosure may be able to realize substantially better performance over SIEM systems by distributing rule generation to networks of peer devices that may further evaluate rule quality and disseminate high quality rules to other devices or to other networks.

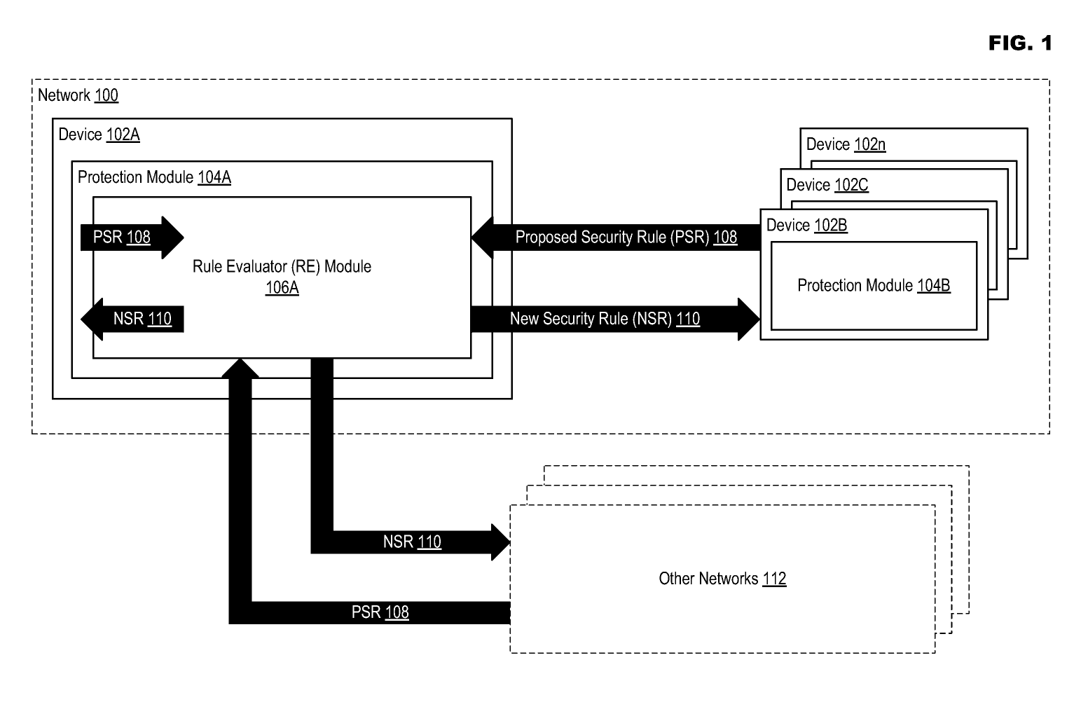

FIG. 1 illustrates an example protection system including security rule evaluation in accordance with at least one embodiment of the present disclosure. Network 100 may be, for example, a local-area network (LAN) or wide-area network (WAN) comprising various equipment such as device 102A, device 102B, device 102C . . . device 102n (collectively “devices 102A . . . n”). Network 100 may comprise any number of electronic equipment that may require protection (e.g., against threats such as unauthorized intrusion, access violation, data leaks, etc.). Examples of devices 102A . . . n may comprise, but are not limited to, a mobile communication device such as a cellular handset or a smartphone based on the Android® OS, iOS®, Windows® OS, Mac OS, Tizen OS, Firefox OS, Blackberry® OS, Palm® OS, Symbian® OS, etc., a mobile computing device such as a tablet computer like an iPad®, Surface®, Galaxy Tab®, Kindle Fire®, etc., an Ultrabook® including a low-power chipset manufactured by Intel Corporation, a netbook, a notebook, a laptop, a palmtop, etc., a typically stationary computing device such as a desktop computer, a server, a set-top box, a smart television, small form factor computing solutions (e.g., for space-limited applications, television-top boxes, etc.) like the Next Unit of Computing (NUC) platform from the Intel Corporation, etc.

In one embodiment, device 102A may comprise protection module 104A, device 102B may comprise protection module 104B, device 102C may comprise protection module 104C . . . device 102n may comprise protection module 104n (collectively, “protection modules 104A . . . n”). Protection modules 104A . . . n may provide protection for network 100 (e.g., devices 102A . . . n) by, for example, detecting, blocking, mitigating and/or remediating threats, intrusions or other security events. These example operations may be implemented in any suitable manner (e.g., in a pro-active fashion, in progress or post-factum) based on security rules. Threats identified by the security rules may be neutralized by protection modules 104A . . . n, by user intervention (e.g., intervention by a network administrator), etc.

In FIG. 1, protection module 104A is further shown to comprise at least RE module 106A. While each protection module 104A . . . n may comprise a corresponding RE module 106A . . . n, only RE module 106A has been illustrated in FIG. 1 for the sake of clarity. RE module 106A may receive proposed security rule (PSR) 108 for evaluation. PSR 108 may be generated within device 102A, may be received from devices 102B . . . n in network 100 (e.g., from protection modules 104B . . . n in devices 102B . . . n) or from other networks 112 (e.g., other networks including at least one device configured similarly to device 102A). In one embodiment, protection module 104A may comprise a machine learning algorithm that may generate PSR 108 based on perceived threats to device 102A or network 100. The machine learning algorithm may, for example, accumulate event data corresponding to the operation of device 102A and/or network 100, program data, contexts, etc., and may formulate PSR 108 based on an analysis of the data (e.g., or at least part of the data). The data may contain events and contexts related to, but not limited to, authentication and/or identification of devices or users, pairing of devices, granting and/or denying access to devices or users, updating/patching of devices and/or software, employees details (e.g., login credentials, employment status, etc.), software-defined networks changes, security (e.g., malware detection, etc.), software (e.g., installation, deployment, execution, prevalence, reputation, etc.), accesses to services (e.g., dynamic host configuration protocol (DHCP), domain name system (DNS), virtual private network (VPN), Internet or LAN domains, universal resource locators (URLs), Internet protocol version 4 (IPv4), Internet protocol version 6 (IPv6), peer-to-peer networks, etc.), inbound communications (e.g., hypertext transfer protocol (HTTP), simple mail transfer protocol (SMTP)/Email, etc.), physical or remote device operation by users or any other suitable device, software or user feature. It may also be possible for a user of device 102A to manually enter PSR 108 into protection module 104A. PSR 108 may comprise, for example, logical tests, definitions, strings and/or other data that may be employed by protection module 110 to identify, and possibly eliminate, threats to network 100 (e.g., including devices 102A . . . n). Example threats may include, but are not limited to, viruses, worms, malware, intrusions, internal breaches, etc.

In an example of operation, RE module 106A may evaluate PSR 108 to determine whether or not to promote PSR 108 to NSR 110 that may be disseminated to some or all of devices 102B . . . n in network 100 and/or to other networks 112. The evaluation may include comparing PSR 108 to a “ground truth scenario” to determine, for example, whether PSR 108 will generate a false positive (FP) or false negative (FN), the probability of generating a FP or FN, etc. The ground truth scenario may comprise, for example, at least one known or proven scenario in which it has been determined that a threat exists or does not exist. During the evaluation, the ground truth scenario may be evaluated by PSR 108 to generate an indication of whether a threat exists in the known good (e.g., no threat exists) or bad (e.g., at least one threat exists) scenario. The indication given by PSR 108 may then be compared to the known threat disposition of the scenario to determine accuracy. PSR 108 may be promoted to NSR 110 if PSR 108 generates an indication corresponding to the known threat disposition of the ground truth scenario.

Promotion may include, for example, NSR 110 being added to a list of active security rules for use by protection module 104A in device 102A, followed by NSR 110 being shared with some or all of devices 102B . . . n in network 100 and/or other networks 112. As a part of promotion, RE module 106A may also determine if a new security rule will overlap or come into a conflict with any existing security rules. In such cases arbitration (e.g. priority-based) may be applied or the overlapping rules may be merged together to remove the overlap. In one embodiment, RE module 106A may determine if NSR 110 needs to be normalized prior to transmission. Normalization may include altering NSR 110 to make it compatible for use with devices 102B . . . n and/or other networks 112. For example, blacklisting of a bad global IPv4 address in NSR 110 may be transmitted “as-is,” while a connection to a high-value asset server in network 100 may require mapping of a local IPv4 address to a universal locator for use by other networks 112. It may also be possible for a recipient of NSR 110 (e.g., devices 102B . . . n) to perform some normalization functions. In particular, the recipient may have the knowledge about how to further customize a normalized NSR 110 prior to deployment (e.g., in a manner that only the recipient may know based on information available to the recipient). For example, the recipient may replace a reference “%high_value_servers_list%” in NSR 110 with an actual list of IP addresses {IP1, IP2, IP3, . . . } prior to making NSR 110 active for use in protecting devices 102B . . . n). In the same or a different embodiment, RE module 106A may select certain devices 102B . . . n and/or certain other networks 112 to which NSR 110 is transmitted. The selection of devices 102B . . . n and/or other networks 112 may be based on criteria including, but not limited to, whether NSR 110 is applicable to devices 102B . . . n and/or other networks 112, whether NSR 110 could interfere with the operation of devices 102B . . . n and/or other networks 112, the burden (e.g., processing, power, etc.) on devices 102B . . . n and/or other networks 112 to enforce NSR 110, whether NSR 110 is duplicative of a security rule already being enforced by devices 102B . . . n and/or other networks 112, etc.

In the same or a different embodiment, RE module 106A may cause an independent evaluation of PSR 108 to take place in addition to the ground truth evaluation. For example, a manual intervention (e.g., by a user of device 102A) or an automated trigger (e.g., without user intervention) may cause PSR 108 to go through independent evaluation. The automated trigger may be random, based on the threat or type of threat PSR 108 is supposed to identify, based on devices 102A . . . n PSR 108 is supposed to protect, etc. The independent evaluation may include an independent source of “live” ground truth including, for example, evaluation in view of an actual (e.g., real-time) scenario whose threat potential has already been assessed under existing security rules, an assessment by a network administrator or classification via another method or system. Given that an independent evaluation has occurred, promotion to NSR 110 may then occur if PSR 108 passes the ground truth evaluation and the independent evaluation.

At least one benefit that may be realized by embodiments consistent with the present disclosure is that devices 102A . . . n may better customize both device-level and network-level protection. The ability to customize protection allows for adequate protection (e.g., readily able to identify a variety of threats) for the entirety of network 100 without the protection becoming problematic (e.g., depleting available processing and/or power resources in devices 102A . . . n, negatively impacting performance in devices 102A . . . n, etc.) for individual devices 102A . . . n. Moreover, sharing PSR 108 with devices 102A . . . n and/or other networks 112 may greatly improve overall protection in that more threat situations may be accounted for.

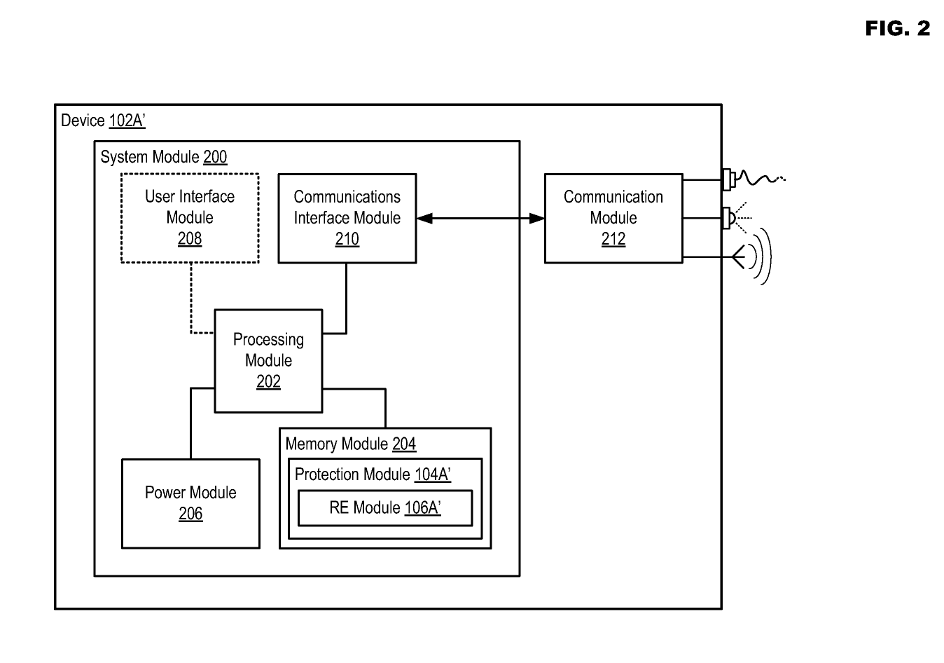

FIG. 2 illustrates an example configuration for device 102A′ in accordance with at least one embodiment of the present disclosure. In particular, device 102A′ may be able to perform example functionality such as disclosed in FIG. 1. However, device 102A′ is meant only as an example of equipment usable in embodiments consistent with the present disclosure, and is not meant to limit these various embodiments to any particular manner of implementation. The example configuration of device 102A′ disclosed in FIG. 2 may also be applicable to devices 102B . . . n also disclosed in FIG. 1.

Device 102A′ may comprise, for example, system module 200 configured to manage device operations. System module 200 may include, for example, processing module 202, memory module 204, power module 206, user interface module 208 and communication interface module 210. Device 102A′ may also include communication module 212 that may interact with communication interface module 210. While communication module 212 has been shown separately from system module 200, the example implementation of device 102A′ has been provided merely for the sake of explanation herein. Some or all of the functionality associated with communication module 212 may also be incorporated in system module 200.

In device 102A′, processing module 202 may comprise one or more processors situated in separate components, or alternatively, one or more processing cores embodied in a single component (e.g., in a System-on-a-Chip (SoC) configuration) and any processor-related support circuitry (e.g., bridging interfaces, etc.). Example processors may include, but are not limited to, various x86-based microprocessors available from the Intel Corporation including those in the Pentium, Xeon, Itanium, Celeron, Atom, Core i-series product families, Advanced RISC (e.g., Reduced Instruction Set Computing) Machine or “ARM” processors, etc. Examples of support circuitry may include chipsets (e.g., Northbridge, Southbridge, etc. available from the Intel Corporation) configured to provide an interface through which processing module 202 may interact with other system components that may be operating at different speeds, on different buses, etc. in device 102A′. Some or all of the functionality commonly associated with the support circuitry may also be included in the same physical package as the processor (e.g., such as in the Sandy Bridge family of processors available from the Intel Corporation).

Processing module 202 may be configured to execute various instructions in device 102A′. Instructions may include program code configured to cause processing module 202 to perform activities related to reading data, writing data, processing data, formulating data, converting data, transforming data, etc. Information (e.g., instructions, data, etc.) may be stored in memory module 204. Memory module 204 may comprise random access memory (RAM) or read-only memory (ROM) in a fixed or removable format. RAM may include volatile memory configured to hold information during the operation of device 102A′ such as, for example, static RAM (SRAM) or Dynamic RAM (DRAM). ROM may include non-volatile (NV) memory modules configured based on BIOS, UEFI, etc. to provide instructions when device 102A′ is activated, programmable memories such as electronic programmable ROMs (EPROMS), Flash, etc. Other fixed/removable memory may include, but are not limited to, magnetic memories such as, for example, floppy disks, hard drives, etc., electronic memories such as solid state flash memory (e.g., embedded multimedia card (eMMC), etc.), removable memory cards or sticks (e.g., micro storage device (uSD), USB, etc.), optical memories such as compact disc-based ROM (CD-ROM), Digital Video Disks (DVD), Blu-Ray Disks, etc.

Power module 206 may include internal power sources (e.g., a battery) and/or external power sources (e.g., electromechanical or solar generator, power grid, fuel cell, etc.), and related circuitry configured to supply device 102A′ with the power needed to operate. In FIG. 2, user interface module 208 has been illustrated as optional in device 102A′ in that some devices (e.g., servers) may not include user interface module 208 but may rely upon other equipment (e.g., remote terminals) to facilitate user interaction. User interface module 208 may include equipment and/or software to allow users to interact with device 102A′ such as, for example, various input mechanisms (e.g., microphones, switches, buttons, knobs, keyboards, speakers, touch-sensitive surfaces, one or more sensors configured to capture images and/or sense proximity, distance, motion, gestures, orientation, etc.) and various output mechanisms (e.g., speakers, displays, lighted/flashing indicators, electromechanical components for vibration, motion, etc.). The equipment in user interface module 208 may be incorporated within device 102A′ and/or may be coupled to device 102A′ via a wired or wireless communication medium.

Communication interface module 210 may be configured to manage packet routing and other control functions for communication module 212, which may include resources configured to support wired and/or wireless communications. In some instances, device 102′ may comprise more than one communication module 212 (e.g., including separate physical interface modules for wired protocols and/or wireless radios) all managed by a centralized communication interface module 210. Wired communications may include serial and parallel wired mediums such as, for example, Ethernet, Universal Serial Bus (USB), Firewire, Digital Video Interface (DVI), High-Definition Multimedia Interface (HDMI), etc. Wireless communications may include, for example, close-proximity wireless mediums (e.g., radio frequency (RF) such as based on the Near Field Communications (NFC) standard, infrared (IR), etc.), short-range wireless mediums (e.g., Bluetooth, WLAN, Wi-Fi, etc.), long range wireless mediums (e.g., cellular wide-area radio communication technology, satellite-based communications, etc.) or communications via sound waves. In one embodiment, communication interface module 210 may be configured to prevent wireless communications that are active in communication module 212 from interfering with each other. In performing this function, communication interface module 210 may schedule activities for communication module 212 based on, for example, the relative priority of messages awaiting transmission. While the embodiment disclosed in FIG. 2 illustrates communication interface module 210 being separate from communication module 212, it may also be possible for the functionality of communication interface module 210 and communication module 212 to be incorporated within the same module.

In the example disclosed in FIG. 2, protection module 104A′ and RE module 106A′ may comprise at least instructions stored in memory module 204 and executed by processing module 202. In an example of operation, protection module 104A′ may generate PSR 108 for RE module 106A′, or alternatively, RE module 106A′ may receive PSR 108 from devices 102B . . . n and/or other networks 112 via communication module 212. Processing module 202 and memory module 204 may then collaborate based on the instructions in RE module 106A′ to determine if PSR 108 should be promoted to NSR 110. RE module 106A′ may then cause communication module 212 to transmit NSR 110 to some or all of devices 102B . . . n and/or other networks 112.

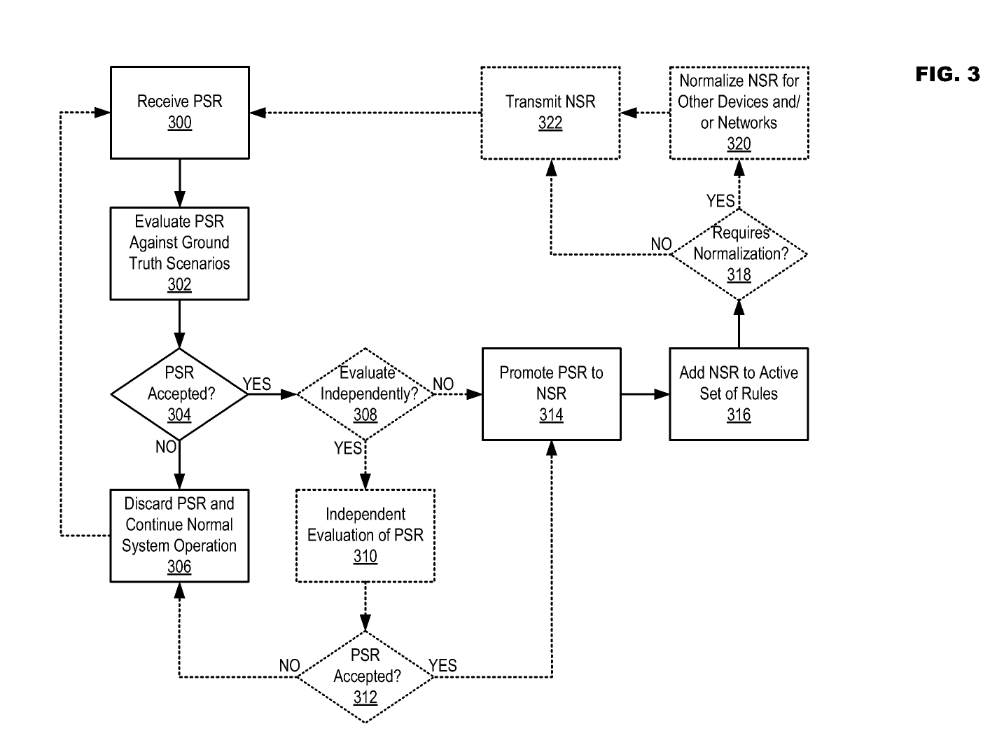

FIG. 3 illustrates example operations for protection a system including security rule evaluation in accordance with at least one embodiment of the present disclosure. In operation 300 a PSR may be received at an RE module in a device that is a member of a network. For example, the PSR may have been generated by a protection module in the same device, or alternatively, may have been received from another device (e.g., from a protection module in the other device) or from other networks outside of the device's network (e.g. a home network, a LAN or a set of LANs/VPNs/software-defined networks (SDNs) comprising an enterprise network, etc.). The PSR received in operation 300 may then be evaluated against at least one ground truth scenario in operation 302. A determination may then be made in operation 304 as to whether the PSR is accepted for promotion to an NSR. If in operation 304 it is determined that the PSR is not accepted (e.g., due to FPs or FNs arising when tested against the at least one ground truth in operation 302, due to lack of need for such a security rule in view of existing security rule coverage, etc.), then in operation 306 the PSR may be discarded and the protection system may continue normal operation (e.g., until another PSR is received back in operation 300).

A determination in operation 304 that the PSR has been accepted may be followed by optional operation 308 wherein a determination may be made as to whether an independent evaluation should occur for the PSR. Operations 308 to 312 may be optional in that it may not be required in every instance to perform an independent evaluation, and consistent with the present disclosure, some protection systems may not require any secondary evaluations. If in operation 308 it is determined that an independent evaluation should occur, then in operation 310 the PSR may proceed through an independent evaluation. A determination may then be made in operation 312 as to whether the PSR should be accepted (e.g. whether the PSR passed the independent evaluation). A determination that the PSR should not be accepted may be followed by a return to operation 306 wherein the PSR may be discarded.

A determination that an independent evaluation should not occur in operation 308, or alternatively a determination that the PSR should be accepted in operation 312, may then be followed by operation 314 wherein the PSR may be promoted to an NSR. The NSR may be added to an active set of rules for use in identifying threats in operation 316. Operations 318 to 322 may be optional in that the operations may apply only if the NSR is to be shared with other devices and/or networks. A determination may be made in operation 318 as to whether the PSR requires normalization prior to transmission. Normalization may comprise, for example, altering the PSR to facilitate compatibility with the other devices and/or networks to which the NSR is being sent. If in operation 318 it is determined that normalization is required, then in operation 320 the NSR may be normalized to facilitate use with the other devices and/or networks. A determination in operation 318 that the NSR does not need to be normalized prior to sharing, or alternatively operation 320, may be followed by operation 322 wherein the NSR may be transmitted to at least one other device and/or network. Operation 322 may optionally be followed by a return to operation 320 for reception of another PSR.

While FIG. 3 may illustrate operations according to an embodiment, it is to be understood that not all of the operations depicted in FIG. 3 are necessary for other embodiments. Indeed, it is fully contemplated herein that in other embodiments of the present disclosure, the operations depicted in FIG. 3, and/or other operations described herein, may be combined in a manner not specifically shown in any of the drawings, but still fully consistent with the present disclosure. Thus, claims directed to features and/or operations that are not exactly shown in one drawing are deemed within the scope and content of the present disclosure.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

As used in any embodiment herein, the term “module” may refer to software, firmware and/or circuitry configured to perform any of the aforementioned operations. Software may be embodied as a software package, code, instructions, instruction sets and/or data recorded on non-transitory computer readable storage mediums. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The modules may, collectively or individually, be embodied as circuitry that forms part of a larger system, for example, an integrated circuit (IC), system on-chip (SoC), desktop computers, laptop computers, tablet computers, servers, smartphones, etc.

Any of the operations described herein may be implemented in a system that includes one or more storage mediums (e.g., non-transitory storage mediums) having stored thereon, individually or in combination, instructions that when executed by one or more processors perform the methods. Here, the processor may include, for example, a server CPU, a mobile device CPU, and/or other programmable circuitry. Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), embedded multimedia cards (eMMCs), secure digital input/output (SDIO) cards, magnetic or optical cards, or any type of media suitable for storing electronic instructions. Other embodiments may be implemented as software modules executed by a programmable control device.

Thus, this disclosure is directed to a protection system including security rule evaluation. A device may comprise a protection module to identify threats to at least one of the device or to a network including the device. The protection module may include, for example, a rule evaluator (RE) module to evaluate proposed security rules for identifying the threats based on at least one ground truth scenario and to determine whether to promote the proposed security rules to new security rules. The proposed security rules may be generated by the protection module or received from other devices in the network or other networks. New security rules may be shared with the other devices and/or networks. The RE module may further trigger an independent evaluation of the proposed security rules, which may also be considered when determining whether to add the proposed security rules to the set of active rules in the device.

The following examples pertain to further embodiments. The following examples of the present disclosure may comprise subject material such as a device, a method, at least one machine-readable medium for storing instructions that when executed cause a machine to perform acts based on the method, means for performing acts based on the method and/or a protection system including security rule evaluation, as provided below.

### EXAMPLE 1

According to this example there is provided a device. The device may comprise a protection module to identify threats to at least one of the device or a network including the device, the protection module including at least a rule evaluator module to evaluate at least one proposed security rule for use by the protection module in identifying the threats based on at least one ground truth scenario, to determine whether to allow the at least one proposed security rule to become at least one new security rule based at least on the evaluation, and if it is determined that the at least one proposed security rule is allowed to become at least one new security rule, to cause the at least one new security rule to be added to an active set of security rules for use by the protection module.

### EXAMPLE 2

This example includes the elements of example 1, wherein the protection module generates the at least one proposed security rule based on a machine learning algorithm for determining threats to the at least one of the device or to the network including the device.

### EXAMPLE 3

This example includes the elements of example 2, wherein the machine learning algorithm is to sense threats existing in at least one of the device or the network to determine the at least one proposed security rule.

### EXAMPLE 4

This example includes the elements of any of examples 1 to 3, wherein the at least one ground truth scenario comprises at least one known good operational scenario or known bad operational scenario.

### EXAMPLE 5

This example includes the elements of example 4, wherein the rule evaluator module being to evaluate the at least one proposed security rule comprises the rule evaluator module being to determine if a threat identification generated by the at least one proposed security rule corresponds to the at least one known good operational scenario or known bad operational scenario.

### EXAMPLE 6

This example includes the elements of any of examples 1 to 5, wherein the rule evaluator module is further to determine whether to cause an independent evaluation of the at least one proposed security rule to be performed.

### EXAMPLE 7

This example includes the elements of example 6, wherein the rule evaluator module is further to cause the independent evaluation of the at least one proposed security rule to be performed and to determine whether to allow the at least one proposed security rule to become the at least one new security rule also based on the independent evaluation.

### EXAMPLE 8

This example includes the elements of any of examples 6 to 7, wherein the independent evaluation comprises evaluation based on at least one of a real time scenario or an assessment of a network administrator.

### EXAMPLE 9

This example includes the elements of any of examples 1 to 8, further comprising a communication module to receive the at least one proposed security rule from at least one of a protection module in another device in the network or from at least one other network.

### EXAMPLE 10

This example includes the elements of example 9, wherein the rule evaluator module is further to cause the communication module to transmit the at least one new security rule to at least one of the other device in the network or to the at least one other network.

### EXAMPLE 11

This example includes the elements of example 10, wherein the rule evaluator module is further to determine if the at least one new security rule requires normalization prior to transmission, and if it is determined that the at least one new security rule requires normalization, to alter the at least one new security rule to facilitate compatibility with at least one of the other device in the network or the at least one other network.

### EXAMPLE 12

This example includes the elements of example 11, wherein at least one other device receiving the at least one normalized new security rule from the device comprises at least a protection module to further normalize the at least one normalized new security rule received from the device based on information available in the at least one other device.

### EXAMPLE 13

This example includes the elements of any of examples 10 to 12, wherein the at least one new security rule is transmitted to the other device in the network or the other network based on a determination of applicability of the at least one new security rule to the other device or the other network by the rule evaluator module.

### EXAMPLE 14

This example includes the elements of any of examples 1 to 13, wherein the at least one ground truth scenario comprises at least one known good operational scenario or known bad operational scenario, the rule evaluator module being to evaluate the at least one proposed security rule comprises the rule evaluator module being to determine if a threat identification generated by the at least one proposed security rule corresponds to the at least one known good operational scenario or known bad operational scenario.

### EXAMPLE 15

This example includes the elements of any of examples 1 to 14, wherein the rule evaluator module is further to determine whether to cause an independent evaluation of the at least one proposed security rule to be performed, if it determined that the independent evaluation should be performed, to cause the independent evaluation of the at least one proposed security rule to be performed and to determine whether to allow the at least one proposed security rule to become the at least one new security rule also based on the independent evaluation.

### EXAMPLE 16

According to this example there is provided a method. The method may comprise evaluating at least one proposed security rule in a device, the at least one proposed security rule being used in the device to identify a threat to at least one of the device or a network including the device based on at least one ground truth scenario, determining whether to allow the at least one proposed security rule to become at least one new security rule based at least on the evaluation, and if it is determined that the at least one proposed security rule is allowed to become at least one new security rule, causing the at least one new security rule to be added to an active set of security rules in the device.

### EXAMPLE 17

This example includes the elements of example 16, and further comprises generating the at least one proposed security rule in the device based on a machine learning algorithm for determining threats to at least one of the device or to the network including the device.

### EXAMPLE 18

This example includes the elements of example 17, wherein determining threats comprises sensing threats existing in at least one of the device or the network to determine the at least one proposed security rule.

### EXAMPLE 19

This example includes the elements of any of examples 16 to 18, wherein the at least one ground truth scenario comprises at least one known good operational scenario or known bad operational scenario.

### EXAMPLE 20

This example includes the elements of example 19, wherein evaluating the at least one proposed security rule comprises determining if a threat identification generated by the at least one proposed security rule corresponds to the at least one known good operational scenario or known bad operational scenario.

### EXAMPLE 21

This example includes the elements of any of examples 16 to 20, and further comprises determining whether to cause an independent evaluation of the at least one proposed security rule to be performed.

### EXAMPLE 22

This example includes the elements of example 21, and further comprises causing the independent evaluation of the at least one proposed security rule to be performed and determining whether to allow the at least one proposed security rule to become the at least one new security rule also based on the independent evaluation.

### EXAMPLE 23

This example includes the elements of any of examples 21 to 22, wherein the independent evaluation comprises evaluation based on at least one of a real time scenario or an assessment of a network administrator.

### EXAMPLE 24

This example includes the elements of any of examples 16 to 23, and further comprises receiving the at least one proposed security rule from at least one of a protection module in another device in the network or from at least one other network.

### EXAMPLE 25

This example includes the elements of any of examples 16 to 24, and further comprises causing the at least one new security rule to be transmitted to at least one of the other device in the network or to the at least one other network.

### EXAMPLE 26

This example includes the elements of example 25, and further comprises determining if the at least one new security rule requires normalization prior to transmission, and if it is determined that the at least one new security rule requires normalization, altering the at least one new security rule to facilitate compatibility with at least one of the other device in the network or the at least one other network.

### EXAMPLE 27

This example includes the elements of example 26, and further comprises receiving the at least one normalized new security rule from the device in at least one other device and further normalizing the at least one normalized new security rule received from the device based on information available in the at least one other device.

### EXAMPLE 28

This example includes the elements of any of examples 16 to 27, wherein the at least one new security rule is transmitted to the other device in the network or the other network based on a determination of applicability of the at least one new security rule to the other device or the other network.

### EXAMPLE 29

This example includes the elements of any of examples 16 to 28, wherein the at least one ground truth scenario comprises at least one known good operational scenario or known bad operational scenario, and further wherein evaluating the at least one proposed security rule comprises determining if a threat identification generated by the at least one proposed security rule corresponds to the at least one known good operational scenario or known bad operational scenario.

### EXAMPLE 30

This example includes the elements of any of examples 16 to 29, and further comprises determining whether to cause an independent evaluation of the at least one proposed security rule to be performed, if it determined that the independent evaluation should be performed, causing the independent evaluation of the at least one proposed security rule to be performed and determining whether to allow the at least one proposed security rule to become the at least one new security rule also based on the independent evaluation.

### EXAMPLE 31

According to this example there is provided a system including a device, the system being arranged to perform the method of any of the above examples 16 to 30.

### EXAMPLE 32

According to this example there is provided a chipset arranged to perform the method of any of the above examples 16 to 30.

### EXAMPLE 33

According to this example there is provided at least one machine readable medium comprising a plurality of instructions that, in response to be being executed on a computing device, cause the computing device to carry out the method according to any of the above examples 16 to 30.

### EXAMPLE 34

According to this example there is provided a device configured for a protection system, including security rule evaluation, the device being arranged to perform the method of any of the above examples 16 to 30.

### EXAMPLE 35

According to this example there is provided a device having means to perform the method of any of the above examples 16 to 30.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

1-25. (canceled)

26. A device, comprising:
a protection module to identify threats to at least one of the device or a network including the device, the protection module including at least a rule evaluator module to:
evaluate at least one proposed security rule for use by the protection module in identifying the threats based on at least one ground truth scenario;
determine whether to allow the at least one proposed security rule to become at least one new security rule based at least on the evaluation; and
if it is determined that the at least one proposed security rule is allowed to become at least one new security rule, cause the at least one new security rule to be added to an active set of security rules for use by the protection module.

27. The device of claim 26, wherein the protection module generates the at least one proposed security rule based on a machine learning algorithm for determining threats to the at least one of the device or to the network including the device.

28. The device of claim 26, wherein the at least one ground truth scenario comprises at least one known good operational scenario or known bad operational scenario.

29. The device of claim 28, wherein the rule evaluator module being to evaluate the at least one proposed security rule comprises the rule evaluator module being to determine if a threat identification generated by the at least one proposed security rule corresponds to the at least one known good operational scenario or known bad operational scenario.

30. The device of claim 26, wherein the rule evaluator module is further to:
determine whether to cause an independent evaluation of the at least one proposed security rule to be performed;
if it determined that the independent evaluation should be performed, cause the independent evaluation of the at least one proposed security rule to be performed; and
determine whether to allow the at least one proposed security rule to become the at least one new security rule also based on the independent evaluation.

31. The device of claim 26, further comprising a communication module to receive the at least one proposed security rule from at least one of a protection module in another device in the network or from at least one other network.

32. The device of claim 31, wherein the rule evaluator module is further to:
cause the communication module to transmit the at least one new security rule to at least one of the other device in the network or to the at least one other network.

33. The device of claim 32, wherein the rule evaluator module is further to:
determine if the at least one new security rule requires normalization prior to transmission; and
if it is determined that the at least one new security rule requires normalization, alter the at least one new security rule to facilitate compatibility with at least one of the other device in the network or the at least one other network.

34. The device of claim 32, wherein the at least one new security rule is transmitted to the other device in the network or the other network based on a determination of applicability of the at least one new security rule to the other device or the other network by the rule evaluator module.

35. A method, comprising:
evaluating at least one proposed security rule in a device, the at least one proposed security rule being used in the device to identify a threat to at least one of the device or a network including the device based on at least one ground truth scenario;
determining whether to allow the at least one proposed security rule to become at least one new security rule based at least on the evaluation; and
if it is determined that the at least one proposed security rule is allowed to become at least one new security rule, causing the at least one new security rule to be added to an active set of security rules in the device.

36. The method of claim 35, further comprising:
generating the at least one proposed security rule in the device based on a machine learning algorithm for determining threats to at least one of the device or to the network including the device.

37. The method of claim 35, wherein the at least one ground truth scenario comprises at least one known good operational scenario or known bad operational scenario.

38. The method of claim 37, wherein evaluating the at least one proposed security rule comprises determining if a threat identification generated by the at least one proposed security rule corresponds to the at least one known good operational scenario or known bad operational scenario.

39. The method of claim 35, further comprising:
determining whether to cause an independent evaluation of the at least one proposed security rule to be performed.
if it determined that the independent evaluation should be performed, causing the independent evaluation of the at least one proposed security rule to be performed; and
determining whether to allow the at least one proposed security rule to become the at least one new security rule also based on the independent evaluation.

40. The method of claim 35, further comprising:
receiving the at least one proposed security rule from at least one of a protection module in another device in the network or from at least one other network.

41. The method of claim 35, further comprising:
causing the at least one new security rule to be transmitted to at least one of the other device in the network or to the at least one other network.

42. The method of claim 41, further comprising:
determining if the at least one new security rule requires normalization prior to transmission; and
if it is determined that the at least one new security rule requires normalization, altering the at least one new security rule to facilitate compatibility with at least one of the other device in the network or the at least one other network.

43. At least one machine-readable storage medium having stored thereon, individually or in combination, instructions that when executed by one or more processors result in the following operations comprising:
evaluating at least one proposed security rule in a device, the at least one proposed security rule being used in the device to identify a threat to at least one of the device or a network including the device based on at least one ground truth scenario;
determining whether to allow the at least one proposed security rule to become at least one new security rule based at least on the evaluation; and
if it is determined that the at least one proposed security rule is allowed to become at least one new security rule, causing the at least one new security rule to be added to an active set of security rules in the device.

44. The medium of claim 43, further comprising instructions that when executed by one or more processors result in the following operations comprising:
generating the at least one proposed security rule in the device based on a machine learning algorithm for determining threats to at least one of the device or to the network including the device.

45. The medium of claim 43, wherein the at least one ground truth scenario comprises at least one known good operational scenario or known bad operational scenario.

46. The medium of claim 45, wherein evaluating the at least one proposed security rule comprises determining if a threat identification generated by the at least one proposed security rule corresponds to the at least one known good operational scenario or known bad operational scenario.

47. The medium of claim 43, further comprising instructions that when executed by one or more processors result in the following operations comprising:
determining whether to cause an independent evaluation of the at least one proposed security rule to be performed.
if it determined that the independent evaluation should be performed, causing the independent evaluation of the at least one proposed security rule to be performed; and
determining whether to allow the at least one proposed security rule to become the at least one new security rule also based on the independent evaluation.

48. The medium of claim 43, further comprising instructions that when executed by one or more processors result in the following operations comprising:
receiving the at least one proposed security rule from at least one of a protection module in another device in the network or from at least one other network.

49. The medium of claim 43, further comprising instructions that when executed by one or more processors result in the following operations comprising:
causing the at least one new security rule to be transmitted to at least one of the other device in the network or to the at least one other network.

50. The medium of claim 49, further comprising instructions that when executed by one or more processors result in the following operations comprising:
determining if the at least one new security rule requires normalization prior to transmission; and
if it is determined that the at least one new security rule requires normalization, altering the at least one new security rule to facilitate compatibility with at least one of the other device in the network or the at least one other network.
